(19) United States
(12) Patent Application Publication
(10) Pub. No.: US 2003/0034724 A1
(43) Pub. Date: Feb. 20, 2003

(54) Impregnated cathode structure and method of manufacturing the structure

(76) Inventor: Daichi Imabayashi, Kanagawa (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 10/204,945

(22) PCT Filed: Dec. 26, 2001
(86) PCT No.: PCT/JP01/11468

(30) Foreign Application Priority Data
Dec. 27, 2000 (JP) 2000-396980

(51) Int. Cl. H01J 19/02; H01J 9/02

(52) U.S. Cl. 313/346 R; 29/592.1

(57) ABSTRACT

An impregnated type cathode unit and a manufacturing method therefor wherein a porous metal base and a cup member can be firmly joined together without using any interposition and the occurrence of weld defects can be eliminated to improve the reliability and yield of welding between the porous metal base and the cup member. The impregnated type cathode unit is composed of a porous metal base (11) impregnated with an electron emissive material and a cup member (12) for holding the porous metal base (11) so as to cover the bottom surface and side surface of the porous metal base (11) and expose the front surface of the porous metal base (11). A nonporous dense portion (14) is formed on the bottom surface of the porous metal base (11). The bottom portion of the cup member (12) is pressed to be deformed so as to follow the shape of the dense portion (14), thereby forming a close contact region (16). The bottom portion of the cup member (12) and the dense portion (14) of the porous metal base (11) are welded together at the close contact region (16).

### TECHNICAL FIELD

The present invention relates to an impregnated type cathode unit having a porous metal base impregnated with an electron emissive material and also to a manufacturing method for the impregnated type cathode unit, and more particularly to an impregnated type cathode unit improved in joining structure between the porous metal base and a cup member for holding the porous metal base so as to cover the bottom surface and side surface thereof and also to a manufacturing method for the impregnated type cathode unit.

### BACKGROUND ART

An impregnated type cathode unit operates at a high current density and has a long life, so that it is heavily used as the cathode of an electron gun for use in a traveling-wave tube to be mounted in a satellite or the like, a cathode-ray tube for a high-quality video system, or an image pickup tube.

The impregnated type cathode unit is composed of a cathode sleeve member, a cup member joined to the top of the cathode sleeve member, and a porous metal base held in the cup member. The porous metal base is impregnated with an electron emissive material. The cup member is formed of a refractory metal. The cathode sleeve member is also formed of a refractory metal.

A porous pellet of tungsten (W) sintered compact having a diameter of about 1 mm, a thickness of about 0.4 mm, and a porosity of about 20%, for example, is used as the porous metal base. The porous pellet may be formed by pelletizing tungsten (w) powder having a particle size of about 5 μm, for example, and then heating to sinter the pelletized tungsten (w) powder.

Tantalum (Ta) is used as the refractory metal for the material of the cup member and the cathode sleeve member.

Various methods for assembling the impregnated type cathode unit by using welding such as resistance welding and laser welding are known.

FIG. 5 shows a method by using resistance welding. As shown in FIG. 5, a porous metal base 1 formed from a porous tungsten (W) pellet impregnated with an electron emissive material is put in a cup member 2 formed of tantalum (Ta) The cup member 2 is then engaged within an upper end portion of a sleeve member 3 formed of tantalum (Ta). The entire outer circumference of the upper end portion of the sleeve member 3 is then crimped and resistance-welded by using crimp welding electrodes 4 to thereby join the porous metal base 1, the cup member 2, and the sleeve member 3.

On the other hand, a method by using laser welding is carried out like the above method by using resistance welding. That is, a porous metal base 1 formed from a porous tungsten (W) pellet impregnated with an electron emissive material is put in a cup member 2 formed of tantalum (Ta) . The cup member 2 is then engaged within an upper end portion of a sleeve member 3 formed of tantalum (Ta). The entire outer circumference of the sleeve member 3 is then laser-welded to thereby join the porous metal base 1, the cup member 2, and the sleeve member 3.

However, these methods have the following problems.

In the method by using resistance welding, the material of the porous metal base 1 and the material of the cup member 2 are not sufficiently melted to such a degree as to form an alloy. Accordingly, the welding strength between the porous metal base 1 and the cup member 2 is small. As a result, in the case of an impregnated type cathode unit manufactured by this method, an aged change in cathode temperature is large, causing a substantial change in grid voltage or cutoff voltage for blocking the emission of thermal electrons. Accordingly, when this impregnated type cathode unit is used for an electron gun, a stable operation cannot be obtained. Furthermore, the entire outer circumference of the sleeve member 3 must be crimped and simultaneously resistance-welded at plural points in this method. Accordingly, the working is generally troublesome and the working time becomes long. In addition, the electrodes 4 for resistance welding must be replaced periodically, causing an increase in manufacturing cost.

On the other hand, the method by using laser welding has an advantage that the welding strength can be sufficiently ensured over the method by using resistance welding. However, it is difficult to control the output of laser light, and there is a case that the electron emissive material contained in the porous metal base and the laser light vigorously react with each other (the electron emissive material is vaporized), and in some case the cup member 2 is perforated. To solve this problem, it is considered that the porous metal base 1 and the cup member 2 are welded before impregnating the porous metal base 1 with the electron emissive material. However, if the porous metal base 1 is impregnated with the electron emissive material after performing the laser welding, the cup member formed of tantalum (Ta) is oxidized to become brittle, resulting in a decrease in mechanical strength.

A method solving these problems has been proposed in Japanese Patent Laid-open Nos. Hei 8-7744 and Hei 10106433.

FIG. 6 shows this method, wherein a thin metal foil chip 5 having a thickness of about 15 to 100 μm is welded by laser light to the bottom surface of a porous metal base 1, and the porous metal base 1 with this metal foil chip 5 is next held in a cup member 2 so that the bottom surface and side surface of the porous metal base 1 are covered with the cup member 2. In this condition, the porous metal base 1 and the cup member 2 are laser-welded through the metal foil chip 5. The porous metal base 1 is formed from a porous tungsten (W) pellet, and the metal foil chip 5 is formed of refractory metal such as molybdenum (Mo) .

According to this metal foil welding method (laser welding), the porous metal base 1 and the cup member 2 can be firmly joined together in spite of the fact that it is unnecessary to weld the cup member over the entire circumference thereof, thereby suppressing an aged change in cathode temperature to reduce a change in cutoff voltage. However, the use of the metal foil chip 5 causes an increase in cost. Furthermore, it is necessary to manage the flatness of the surface of the metal foil chip 5 welded to the porous metal base 1, so as to securely laser-weld the porous metal base 1 and the cup member 2 through the metal foil chip 5. Such flatness management is difficult to perform.

Specifically, numerous pores are present on the surface of the porous metal base 1, so that the surface of the porous metal base 1 to which the metal foil chip 5 is to be welded is not flat. Moreover, since the metal foil chip 5 itself is very thin and therefore somewhat curved, the surface of the metal foil chip 5 is not completely flat. Accordingly, when the metal foil chip 5 is put on the bottom surface of the porous metal base 1, a clearance is generated between the metal foil chip 5 and the porous metal base 1. If the metal foil chip 5 is welded to the bottom surface of the porous metal base 1 in the condition where the above clearance is present, a nonflat portion such as projections and depressions appears on the surface of the metal foil chip 5.

Further, in welding the metal foil chip 5 to the bottom surface of the porous metal base 1, laser light is directed onto the metal foil chip 5 in an atmosphere of inert gas such as argon or nitrogen, so as to prevent the oxidization of the porous metal base 1 and the metal foil chip 5. However, the flatness of the surface of the metal foil chip 5 after welded varies according to the welding atmosphere, the spray rate and direction of the inert gas, the irradiation conditions with the laser light, etc.

If the porous metal base 1 with the metal foil chip 5 is held in the cup member 2 to be welded by laser light in the condition where the nonflat portion is present on the surface of the metal foil chip 5, there is a case that the porous metal base 1 may be tilted with respect to the cup member 2, causing the perforation of the cup member 2 by the irradiation with laser light.

The perforation of the cup member 2 causes a problem that a leakage current is generated through this perforation to a heater in the case of using an electron gun including this impregnated type cathode unit, so that a stable operation cannot be obtained.

Further, if the porous metal base 1 is tilted with respect to the cup member 2, weld defects due to the occurrence of unwelded points are apt to occur, causing a possibility of separation of the porous metal base 1 from the cup member 2. Even if the cup member 2 is welded to the porous metal base 1 in this tilted condition, the porous metal base 1 tilted may come into contact with the grid to be spaced apart from the porous metal base 1 by a given distance (e.g., 100 μm) As a result, the electron gun as a product may become defective such that thermal electrons cannot be emitted and the function of the electron gun cannot be performed.

It is accordingly an object of the present invention to provide an impregnated type cathode unit and a manufacturing method therefor wherein a porous metal base and a cup member can be firmly welded together without using any interposition such as a metal foil chip causing a cost increase.

It is another object of the present invention to provide an impregnated type cathode unit and a manufacturing method therefor wherein the shapes of the porous metal base and the cup member for holding the porous metal base are optimized to thereby eliminate the occurrence of weld defects and accordingly improve the reliability and yield of the welding between the porous metal base and the cup member.

It is a further object of the present invention to provide an impregnated type cathode unit and a manufacturing method therefor wherein the time required for the welding between the porous metal base and the cup member can be shortened to thereby reduce a manufacturing cost.

### DISCLOSURE OF INVENTION

According to an aspect of the present invention, there is provided an impregnated type cathode unit composed of a porous metal base impregnated with an electron emissive material and a cup member for holding the porous metal base so as to cover the bottom surface and side surface of the porous metal base and expose the front surface of the porous metal base, characterized in that a dense portion is formed on the bottom surface of the porous metal base, in that the bottom portion of the cup member is pressed to be deformed so as to follow the shape of the dense portion, thereby forming a close contact region, and in that the bottom portion of the cup member and the dense portion of the porous metal base are welded together at the close contact region.

With this configuration, a part of the porous metal base is formed as the dense portion which is nonporous, and the bottom portion of the cup member is deformed by pressing so as to follow the shape of the dense portion, thereby forming the close contact region between the porous metal base and the cup member. Then, the porous metal base and the cup member are welded together at this close contact region. Accordingly, the cup member and the porous metal base can be firmly joined together by laser welding or the like without using any interposition such as a metal foil chip.

Preferably, the dense portion of the porous metal base is formed with a convex portion, the bottom portion of the cup member is formed with a projecting contact portion adapted to come into contact with the convex portion of the dense portion, and the close contact region is formed by pressing the projecting contact portion to deform it so as to follow the shape of the convex portion of the dense portion.

With this configuration, the dense portion of the porous metal base has the convex portion, and the bottom portion of the cup member has the projecting contact portion adapted to come into contact with the convex portion of the dense portion. The projecting contact portion is pressed to be deformed so as to follow the shape of the convex portion of the dense portion, thereby forming the close contact region. Then, laser welding is performed at this close contact region in the condition where no clearance is formed between the projecting contact portion deformed and the convex portion of the dense portion Accordingly, the cup member and the porous metal base can be reliably welded without the occurrence of weld defects.

Preferably, the thickness of the dense portion of the porous metal base is set to at least more than 10 μm.

By setting the thickness of the dense portion to at least more than 10 μm, the cup member and the porous metal base can be laser-welded without any influence on the electron emissive material contained in the porous metal base.

More preferably, the width “r” of the dense portion of the porous metal base, the width “d” of the convex portion of the dense portion, the depth “1” of a concave portion of the dense portion formed on the opposite sides of the convex portion from the bottom surface of the porous metal base, the height “a” of the projecting contact portion of the cup member, the width “b” of the projecting contact portion at the bottom side thereof, and the width “c” of the projecting contact portion at the top side thereof are set so as to satisfy the relations of a ≦1, b≦r, and d <c.

By setting the above relations between the dimensions of the dense portion of the porous metal base and the dimensions of the projecting contact portion of the bottom portion of the cup member, the porous metal base can be prevented from separating from the bottom surface of the cup member, and the close contact region between the cup member and the porous metal base can be sufficiently ensured for laser welding. Accordingly, the welding condition can be further stabilized.

According to another aspect of the present invention, there is provided a manufacturing method for an impregnated type cathode unit composed of a porous metal base impregnated with an electron emissive material and a cup member for holding the porous metal base so as to cover the bottom surface and side surface of the porous metal base and expose the front surface of the porous metal base, comprising the steps of preliminarily forming a dense portion on the bottom surface of the porous metal base prior to impregnating the porous metal base with the electron emissive material, holding the porous metal base having the dense portion within the cup member so that the bottom surface and side surface of the porous metal base are covered with the cup member and the front surface of the porous metal base is exposed, pressing the bottom portion of the cup member to deform it so as to follow the shape of the dense portion, thereby forming a close contact region, laser-welding the bottom portion of the cup member and the dense portion of the porous metal base at the close contact region.

With this configuration, the dense portion is preliminarily formed by irradiating the bottom surface (back surface) of the porous metal base with laser light or the like to thereby partially melt a porous portion of the porous metal base. The porous metal base having the dense portion is next held within the cup member, and the bottom portion of the cup member is next pressed to be deformed so as to follow the shape of the dense portion, thereby forming the close contact region. The cup member and the porous metal base are next laser-welded together at this close contact region. According to this method, the cup member and the porous metal base can be firmly laser-welded directly with no clearance therebetween without using any interposition.

Preferably, the porous metal base is impregnated with the electron emissive material at a suitable time after the step of forming the dense portion.

By impregnating the porous metal base with the electron emissive material after forming the dense portion on the bottom surface of the porous metal base, any influence on the electron emissive material contained in the porous metal base in performing laser welding can be prevented.

### BRIEF DESCRIPTION OF DRAWINGS

FIG. 1 is a process flow diagram showing the configuration of an impregnated type cathode unit and a manufacturing method for the impregnated type cathode unit according to a preferred embodiment of the present invention.

FIG. 2 is an enlarged sectional view showing a welding region between a porous metal base and a cup member constituting the impregnated type cathode unit.

FIG. 3 is a sectional view showing the configuration of the porous metal base.

FIG. 4 is a sectional view showing the configuration of the cup member.

FIG. 5 is a sectional view for illustrating a manufacturing method for an impregnated type cathode unit by using resistance welding in the prior art.

FIG. 6 is a process flow diagram showing a manufacturing method for an impregnated type cathode unit by using a metal foil welding method in the prior art.

### BEST MODE FOR CARRYING OUT THE INVENTION

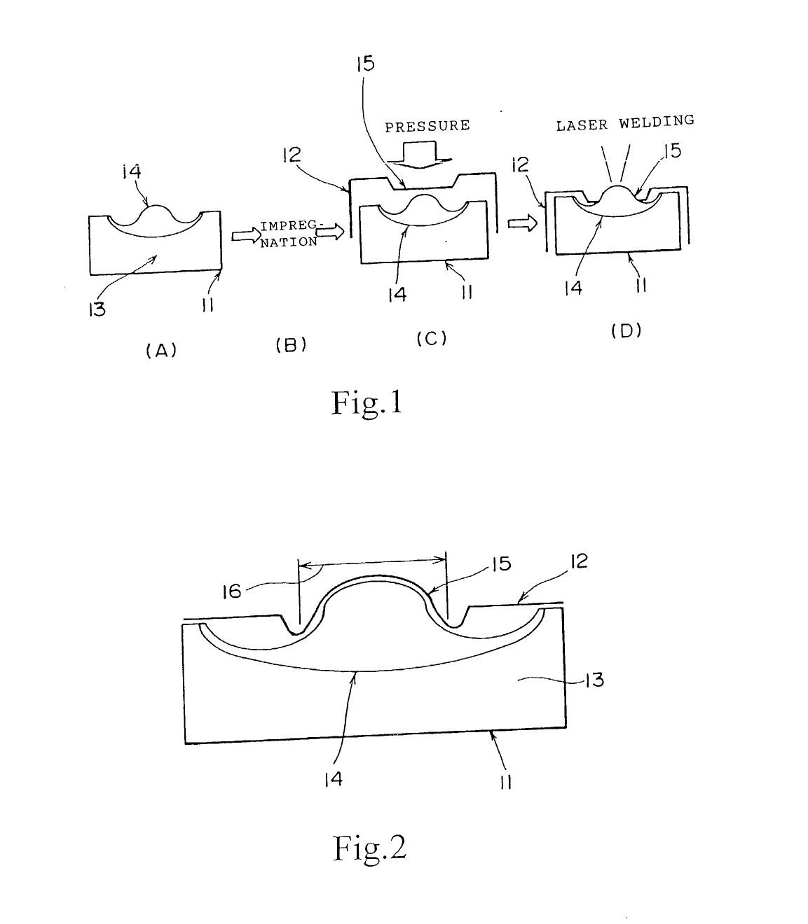

A preferred embodiment of the present invention will now be described with reference to FIGS. 1 to 4.

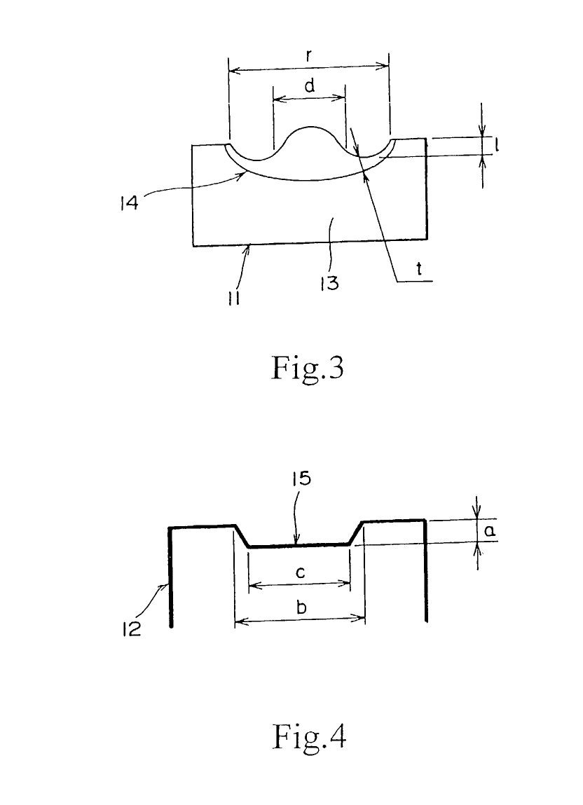

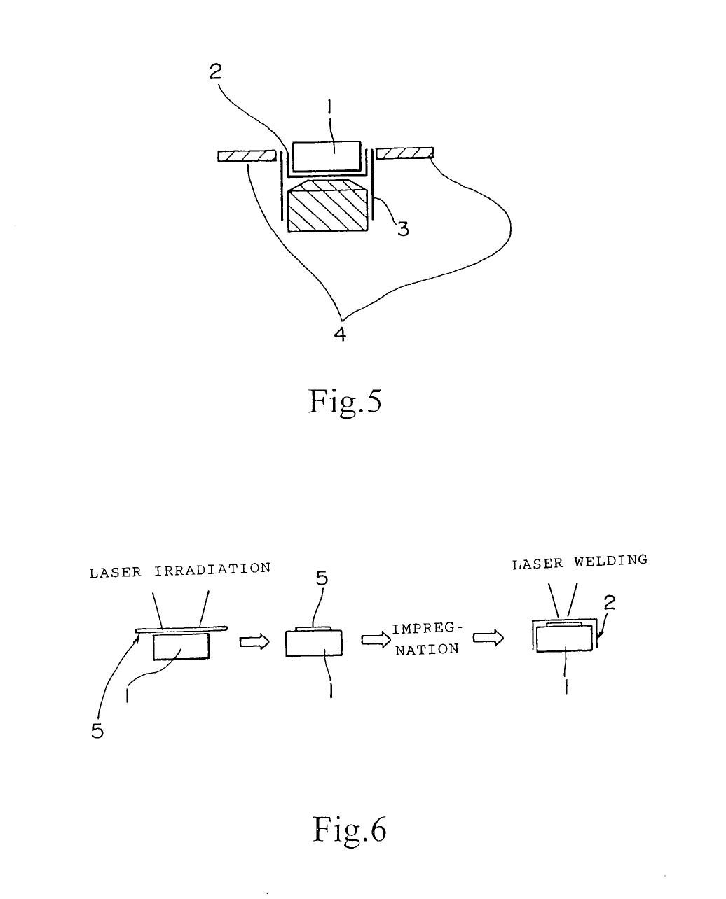

FIG. 1 is a process flow diagram showing the configuration of an impregnated type cathode unit according to a preferred embodiment of the present invention and a manufacturing method for the impregnated type cathode unit, FIG. 2 is an enlarged sectional view showing a welding region between a porous metal base and a cup member constituting the impregnated type cathode unit, FIG. 3 is a sectional view showing the configuration of the porous metal base, and FIG. 4 is a sectional view showing the configuration of the cup member.

In the neck of a color cathode-ray tube, an electron gun is incorporated. The electron gun has a function of emitting electron beams. The electron gun is composed of a cathode assembly and a plurality of grid electrodes. The cathode assembly includes three impregnated cathode units for R, G, and B.

Each impregnated type cathode unit is composed of a cathode sleeve member, a cup member 12 joined to the top of the cathode sleeve member, and a porous metal base 11 held in the cup member 12. The porous metal base 11 is formed from a porous tungsten (W) pellet impregnated with an electron emissive material. The cup member 12 is formed of a refractory metal such as tantalum (Ta) . The cathode sleeve member is also formed of a refractory metal such as tantalum (Ta).

There will now be described a detailed structure of the impregnated type cathode unit and a manufacturing method therefor.

A porous tungsten (W) pellet having a diameter of about 1 mm, a thickness of about 0.4 mm, and a porosity of about 20%, for example, is used as the porous metal base 11. The porous tungsten (W) pellet may be formed by pelletizing tungsten (W) powder having a particle size of about 5 μm, for example, and then heating to sinter the pelletized tungsten (W) powder.

The back surface of the porous metal base 11 is irradiated with laser light to partially melt a porous portion 13, thereby forming a dense portion 14 less porous or harder than the porous portion 13 as shown in FIG. 1(A).

As shown in FIG. 3, the dense portion 14 is convex at its central portion and concave on the opposite sides thereof. The thickness t of the dense portion 14 is set to at least more than 10 μm so that the electron emissive material contained in the porous metal base 11 is not influenced by laser welding to the cup member 12 to be hereinafter described.

The width of the dense portion 14 is set to r, the width of the convex portion is set to d, and the depth of the concave portion from the bottom surface of the porous metal base 11 is set to 1.

On the other hand, the cup member 12 for holding the porous metal base 11 so as to cover the bottom surface and side surface of the porous metal base 11 is formed of tantalum (Ta) as a refractory metal. The cup member 12 has a structure such that the porous metal base 11 is held in the cup member 12 in the condition where the front surface of the porous metal base 11 is exposed to allow the emission of electrons in the electron emissive material and that the dense portion 14 of the porous metal base 11 can be firmly joined to the bottom portion of the cup member 12 by laser welding.

As shown in FIG. 4, the bottom portion of the cup member 12 is formed at its central portion with a contact portion 15 projecting toward the bottom surface of the porous metal base 11. The contact portion 15 is trapezoidal in cross section so that the height is set to a, the width at the bottom side is set to b, and the width at the top side is set to c.

The dimensions a, b, and c of the contact portion 15 of the cup member 12 and the dimensions r, d, and 1 of the dense portion 14 of the porous metal base 11 satisfy the relations of a ≦1, b≦r, and d≦c.

The porous metal base 11 and the cup member 12 are joined together to manufacture the impregnated type cathode unit in the following manner. In the first step shown in FIG. 1(A), the dense portion 14 is formed by directing laser light on a part of the bottom surface of the porous metal base 11. In the next step shown in FIG. 1(B), the porous metal base 11 prepared above is impregnated with an electron emissive material.

This impregnation step may be carried out at a suitable time after the step of forming the dense portion 14 shown in FIG. 1 (A) .

In the next step shown in FIG. 1(C), the cup member 12 is placed so as to hold the porous metal base 11 impregnated with the electron emissive material in such a manner as to cover the bottom surface of the porous metal base 11 on which the dense portion 14 is formed and the side surface of the porous metal base 11. In this holding condition, the projecting contact portion 15 of the cup member 12 is in contact with the convex portion of the dense portion 14 of the porous metal base 11. Thereafter, the projecting contact portion 15 of the cup member 12 is pressed to be deformed so that the projecting contact portion 15 comes into close contact with the convex portion of the dense portion 14 so as to follow the convex shape thereof.

As a result, the porous metal base 11 and the cup member 12 combined together as above become a condition as shown in FIG. 2 where the projecting contact portion 15 of the cup member 12 is deformed into a region 16 completely closely fitted with the convex portion of the dense portion 14 of the porous metal base 11, that is, in close contact with the convex portion with no clearance. This close contact region 16 is formed as a laser weldable region. As described above, the dimensions a, b, and c of the projecting contact portion 15 of the cup member 12 and the dimensions r, d, and 1 of the dense portion 14 of the porous metal base 11 are set to satisfy the relations of a ≦1, b≦r, and d≦c. Therefore, the porous metal base 11 can be prevented from separating from the bottom surface of the cup member 12, and the close contact region (laser weldable region) 16 between the dense portion 14 and the projecting contact portion 15 can be maximized in contact area.

In the next step shown in FIG. 1(D), the close contact region (laser weldable region) 16 between the dense portion 14 of the porous metal base 11 and the projecting contact portion 15 of the cup member 12 is irradiated with laser light to thereby laser-weld these portions 14 and 15. Thus, these portions 14 and 15 are welded together with no clearance, so that the porous metal base 11 and the cup member 12 can be joined together by laser welding reliably and firmly.

According to this preferred embodiment, the porous metal base 11 and the cup member 12 constituting the impregnated type cathode unit are so formed as to respectively have the dense portion 14 with the convex portion and the projecting contact portion 15. The projecting contact portion 15 of the cup member 12 is pressed to be deformed so as to follow the shape of the convex portion of the dense portion 14 of the porous metal base 11, thereby forming the close contact region 16 between the dense portion 14 and the projecting contact portion 15 deformed with no clearance therebetween. At this close contact region 16, the porous metal base 11 and the cup member 12 are directly joined together by laser welding. Accordingly, the following effects that cannot be obtained by the conventional resistance welding method, laser welding method, or metal foil welding method can be expected according to this preferred embodiment.

(1) Since the porous metal base 11 and the cup member 12 are directly joined together by laser welding, these members 11 and 12 can be welded reliably and firmly, thereby improving the reliability of welding and minimizing an aged change in cathode temperature in the impregnated type cathode unit to reduce the range of fluctuations in cutoff voltage. As a result, the quality of the impregnated type cathode unit can be improved to thereby stabilize the operation of the electron gun.

(2) Since the close contact region 16 can be formed between the dense portion 14 and the projecting contact portion 15 with no clearance and laser welding can be performed at this region 16, any weld defects such as perforation and unwelded points of the cup member can be eliminated to thereby improve the yield of welding and reduce the rate of occurrence of defective parts.

(3) Since the porous metal base 11 and the cup member 12 are directly laser-welded without using any interposition such as a metal foil chip, a cost corresponding to the interposition can be reduced.

(4) Since the porous metal base 11 and the cup member 12 can be welded by directing laser light onto the close contact region 16, the time required for the welding can be shortened to thereby reduce a manufacturing cost.

(5) Since the thickness t of the dense portion 14 is set to at least more than 10 μm to allow the laser welding without any influence on the electron emissive material contained in the porous metal base 11, the step of impregnating the porous metal base 11 with the electron emissive material can be set at any arbitrary point in the manufacturing process. Thus, the degree of freedom of flow of the process can be ensured.

(6) Since the shapes and dimensions of the dense portion 14 and the projecting contact portion 15 are optimized, a uniform and stable welding accuracy and welding strength can be obtained.

According to the present invention as described above, it is possible to provide an impregnated type cathode unit and a manufacturing method therefor wherein the porous metal base and the cup member can be firmly welded together without using any interposition such as a metal foil chip causing a cost increase.

Accordingly, the quality of the impregnated type cathode unit can be improved and the operation of the electron gun can be stabilized. Furthermore, a cost reduction can be effected.

Further, by optimizing the shapes of the porous metal base and the cup member for holding the porous metal base, the occurrence of weld defects can be eliminated to thereby improve the reliability and yield of the welding between the porous metal base and the cup member. As a result, the rate of occurrence of defective parts can be greatly reduced, and the welding accuracy and welding strength can be uniformed to improve the quality of the product.

Moreover, the time required for the welding between the porous metal base and the cup member can be shortened to thereby reduce a manufacturing cost. The laser welding can be performed with no influence on the electron emissive material contained in the porous metal base, so that the step of impregnating the porous metal base with the electron emissive material can be set at any arbitrary optimum position in the manufacturing process.

1. An impregnated type cathode unit composed of a porous metal base impregnated with an electron emissive material and a cup member for holding said porous metal base so as to cover the bottom surface and side surface of said porous metal base and expose the front surface of said porous metal base, characterized in that a dense portion is formed on the bottom surface of said porous metal base, in that the bottom portion of said cup member is pressed to be deformed so as to follow the shape of said dense portion, thereby forming a close contact region, and in that the bottom portion of said cup member and said dense portion of said porous metal base are welded together at said close contact region.

2. An impregnated type cathode unit according to claim 1, wherein said dense portion of said porous metal base is formed with a convex portion, the bottom portion of said cup member is formed with a projecting contact portion adapted to come into contact with said convex portion of said dense portion, and said close contact region is formed by pressing said projecting contact portion to deform it so as to follow the shape of said convex portion of said dense portion.

3. An impregnated type cathode unit according to claim 1 or 2, wherein the thickness of said dense portion of said porous metal base is set to at least more than 10 μm.

4. An impregnated type cathode unit according to claim 2 or 3, wherein the width “r” of said dense portion of said porous metal base, the width “d” of said convex portion of said dense portion, the depth “1” of a concave portion of said dense portion formed on the opposite sides of said convex portion from the bottom surface of said porous metal base, the height “a” of said projecting contact portion of said cup member, the width “b” of said projecting contact portion at the bottom side thereof, and the width “c” of said projecting contact portion at the top side thereof are set so as to satisfy the relations of a ≦1, b≦r, and d≦c.

5. A manufacturing method for an impregnated type cathode unit composed of a porous metal base impregnated with an electron emissive material and a cup member for holding said porous metal base so as to cover the bottom surface and side surface of said porous metal base and expose the front surface of said porous metal base, comprising the steps of preliminarily forming a nonporous dense portion on the bottom surface of said porous metal base prior to impregnating said porous metal base with said electron emissive material, holding said porous metal base having said dense portion within said cup member so that the bottom surface and side surface of said porous metal base are covered with said cup member and the front surface of said porous metal base is exposed, pressing the bottom portion of said cup member to deform it so as to follow the shape of said dense portion, thereby forming a close contact region, laser-welding the bottom portion of said cup member and said dense portion of said porous metal base at said close contact region.

6. A manufacturing method according to claim 5, wherein said porous metal base is impregnated with said electron emissive material at a suitable time after said step of forming said dense portion.
